(19) United States
(12) Patent Application Publication
(10) Pub. No.: US 2015/0270657 A1
(43) Pub. Date: Sep. 24, 2015

(54) REVERSIBLE ELECTRICAL CONNECTOR

(71) Applicant: DONGGUAN XUNTAO ELECTRONICS CO., LTD., Dongguan City (CN)

(72) Inventors: MIN FAN, Dongguan City (CN); YUN FENG, Dongguan City (CN)

(21) Appl. No.: 14/472,357

(22) Filed: Aug. 28, 2014

(30) Foreign Application Priority Data
Mar. 18, 2014 (CN) 201420123602.1

(51) Int. Cl. H01R 24/60

(52) U.S. Cl. CPC H01R 24/60

(57) ABSTRACT

An electrical connector comprises an insulative housing; a chamber divided into a pair of upper and lower chambers; a set of first contacts having contacting portions, connecting portions, and resilient suspending portions; and a set of second contacts electrically connecting to the first contacts, the second contacts having contacting portions aligned to the respective contacting portions of the first contacts. The suspending portions could resiliently swing in a height direction, and the contacting portions of the first and second contacts can move upwardly and downwardly accompanying with swing of the suspending portion.

### BACKGROUND OF THE INVENTION

1. Field of the Invention

The present invention relates to an electrical connector, and more particularly to a reversible electrical connector.

2. Description of Related Art

USB connectors are widely used at various market fields, such as Desktop, Notebook, Tablet, USB Flash Disk etc, for USB data transmission. The USB connectors usually comprises USB receptacle connectors deployed at host devices such as Desktop, Notebook, and USB plug connectors deployed at portable storage device such as USB Flash Disks and Cable assemblies. When the USB plug connectors are to be mated with the USB receptacle connectors, users or consumers need to insert the USB plug connectors into the USB receptacle connectors in a normal orientation or correct state so as to make sure they can mate with each other correctly. But sometimes users or consumers cannot see and make out the situation or outline of the USB receptacle connector, and often insert the USB plug connectors into the USB receptacle connector in an incorrect option and have to insert the USB plug connector into the USB receptacle connector again in an alternative right option. Thus, it is very inconvenient for users or consumers to use.

Hence, an improved electrical connector for solving the above issue is desired.

### BRIEF SUMMARY OF THE INVENTION

According to an aspect of the present invention, an electrical connector comprises an insulative housing; a chamber having upper and lower chambers; a plurality of first contacts, each having a contacting portion exposed into one of the upper or lower chambers, a connecting portion retained in the insulative housing, and a resilient suspending portion connecting with the contacting portion and the connecting portion; and a plurality of second contacts, each electrically connecting to respective first contact and having a contacting portion exposed into the other one chamber and aligned to the respective contacting portion of the first contacts. The suspending portions could resiliently swing in a height direction, and the contacting portions of the first and second contacts can be displaced in the height direction.

According to another aspect of the present invention, an electrical connector for reversibly mating with a complementary connector, comprises a metal shell defining a chamber; a tongue plate disposed in the chamber and dividing the chamber into two symmetrical half chambers; a plurality of first contacts defining contacting portions located at a surface of the tongue plate and exposed into one of the half chambers for contacting with a group of terminals of the complementary connector when the electrical connector mating with the complementary connector in a normal orientation; and a plurality of second contacts, each electrically connecting to one respective first contact, the second contacts defining contacting portions arranged at an opposing surface of the tongue plate and being exposed into the other one of said half chambers for contacting with said group of terminals of the complementary connector when the electrical connector mating with the complementary connector in a reverse orientation. Each of said first contacts has resilient suspending portion extending from the respective contacting portion for resiliently bending in a height direction, and the tongue plate pivoted with the contacting portions to adjust dimensions of the half chambers for the complementary connector.

According to a third aspect of the present invention, a reversible electrical connector comprises a metal shell defining a chamber having two symmetrical upper and lower chambers; an inner circuit board disposed between the upper and lower chambers; a plurality of first contacts having contacting portions deployed on an upper surface of the inner circuit board and exposed into the upper chamber, and resilient suspending portions extending from the contacting portions away to the inner circuit board; and a plurality of second contacts electrically connecting to the first contacts, each of the second contacts having a contacting portion mounted onto a lower surface of the inner circuit board and exposed into the lower chamber, each of said the contacting portions of the second contacts being electrically connected to each one contacting portion of the respective first contact. The suspending portions resiliently bend in a height direction and the inner circuit board pivots with the contacting portions when a matched connector inserted in said chamber.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of an electrical connector in accordance with an illustrated embodiment of the present invention;

FIG. 2 is a section view taken along a direction of A2-A2 in the view of FIG. 1;

FIG. 3 is a partly exploded view of the electrical connector with a metal shell separated from an insulative housing as shown in FIG. 1;

FIG. 4 is an exploded view of the electrical connector as shown in FIG. 1;

FIG. 5 is another exploded view of the electrical connector as shown in FIG. 4 while taken from a different aspect;

FIG. 6 is a further exploded view of the electrical connector as shown in FIG. 5; and

FIG. 7 is a partly exploded view of an electrical connector in accordance with another embodiment of the present invention with a metal shell separated from an insulative housing.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

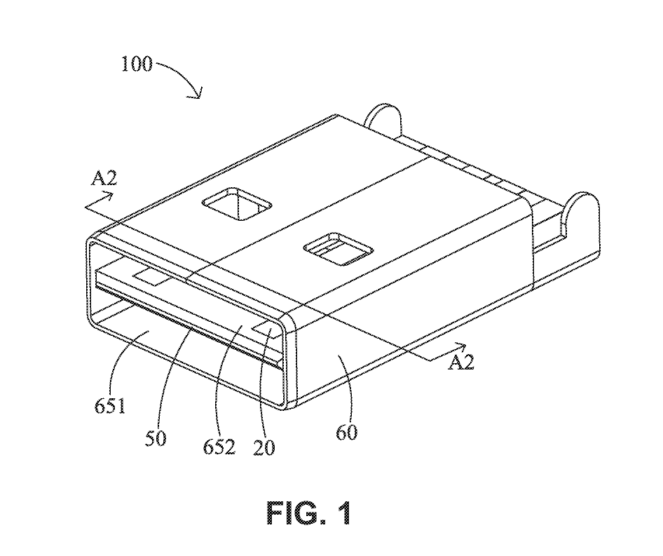

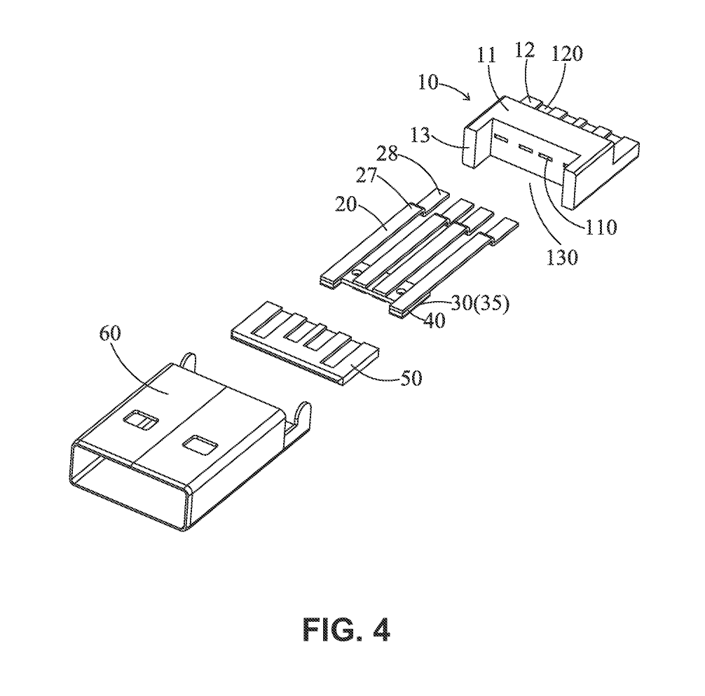

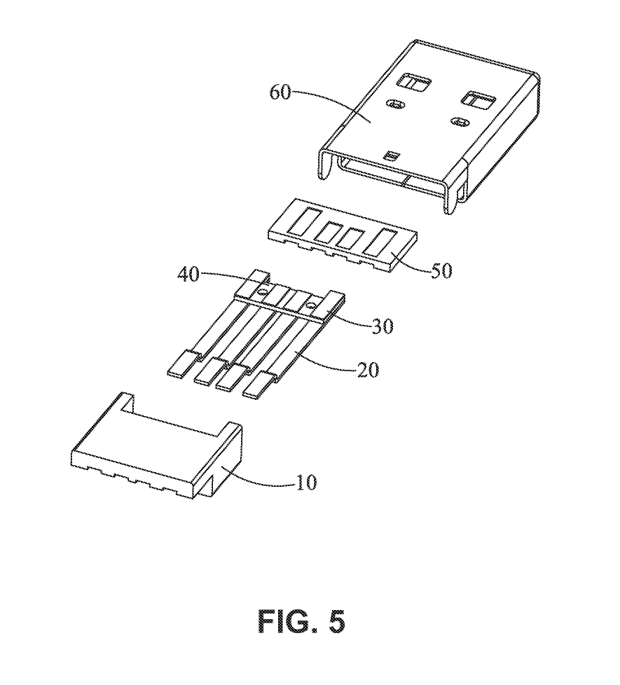

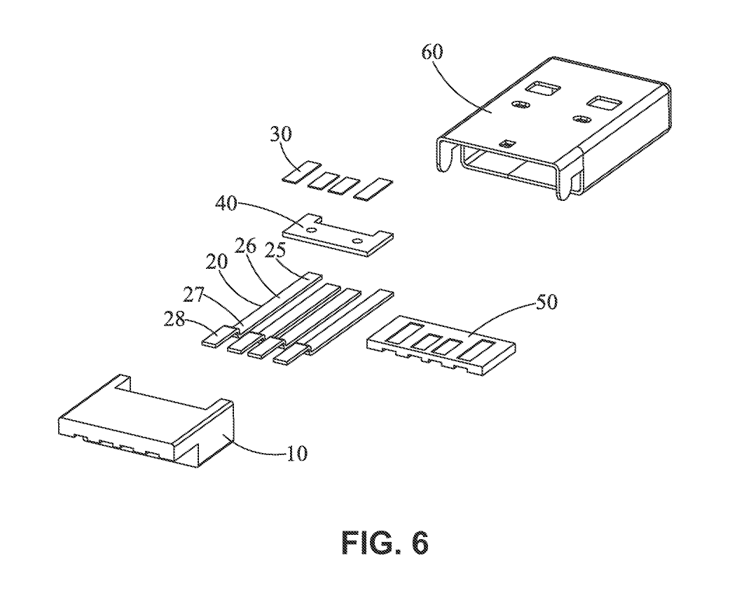

Referring to FIGS. 1 to 6, the present invention discloses an electrical connector 100 compatible to type-A USB 2.0 standard. According to the illustrated embodiment of the present invention, the electrical connector 100 is a plug connector applied to connect with USB 2.0 cable assembles or mobile storage devices (e.g. U-disk). The electrical connector 100 includes an insulative housing 10, a plurality of first contacts 20, a plurality of second contacts 30 being adapted to mate with first contacts 20 respectively, an inner circuit board 40 to electrically connect the first contacts 20 with the second contacts 30 respectively, an insulator 50 to secure the first contacts 20 and the second contacts 30, and a metal shell 60 surrounding the insulator 50.

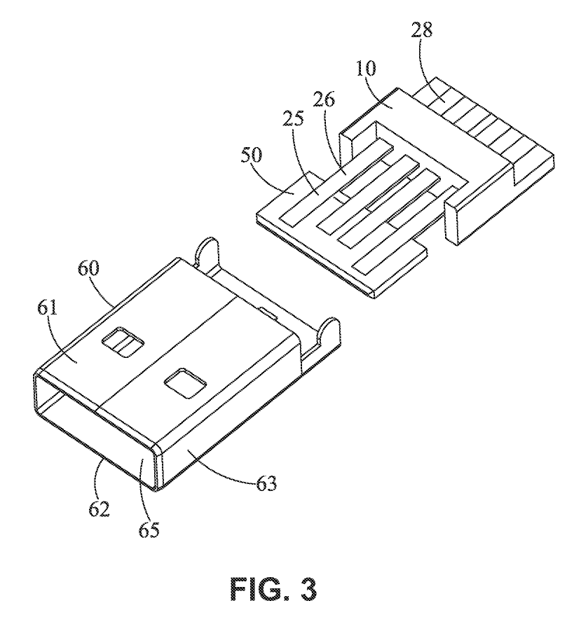

Referring to FIGS. 3-5, the insulative housing 10 presents as an L shape while viewed from a side view thereof The insulative housing 10 includes a main body 11, a supporting portion 12 extending rearwardly from a bottom side and rear end of the main body 11, and a pair of extending portions 13 extending forwardly from two sides of a front end of the main body 11. The main body 11 has a set of through holes 110 passing therethrough in the front-to-rear direction of the insulative housing 10. A plurality of grooves 120 are recessed downwardly from an upper surface of the supporting portion 12 and arranged in one row in a width direction of the insulative housing 10 perpendicular to the front-to-rear direction. The through holes 110 are arranged in another row higher than the grooves 120 and communicating with the grooves 120 respectively. The extending portions 13 align with each other in the width direction and locate at two sides of the through holes 110 to form a receiving space 130 therebetween. The receiving space 130 communicates with the through holes 110 in the front-to-rear direction.

Each of the first contacts 20 includes a contacting portion 25, a suspending portion 26 extending backwardly from the contacting portion 25, a tail portion 28 retained into the groove 120 and exposed to exterior for connecting to a printed circuit board or an electrical wire, and a connecting portion 27 connecting with the suspending portion 26 and the tail portion 28 and being received in the through hole 110 so as to be retained in the insulative housing 10 firmly. The suspending portion 26 locates at the same height as the contacting portion 25. The suspending portion 26 is resilient and suspended in the receiving space 130, the connecting portion 27 is retained into the through hole 110, therefore, the suspending portion 26 could resiliently swing in a height direction around the connecting portion 27 so as to make sure the contacting portion 25 can move in the height direction accompanying with swing of the suspending portion 26. In the present embodiment, the first contacts 20 could be assembled to the insulative housing 10 or insert molded into the insulative housing 10.

The amounts of the first and second contacts 20, 30 are the same. Both of the first contacts 20 and the second contacts 30 are compatible to USB 2.0 standard, to be specific, from a functional viewpoint, both the first contacts 20 and the second contacts 30 include a grounding contact 21, 31, a power contact 22, 32, and a pair of signal contacts 23, 33 arranged between the grounding contact 21, 31 and the power contact 22, 32 respectively, under condition that the second contacts 30 are arranged in a reverse order compared with the first contacts 20.

The second contacts 30 are spaced from the insulative housing 10 from a distance in the front-to-rear direction and are separated from the first contacts 20 in the height direction. Each second contact 30 merely has a contacting portion 35 aligned with the contacting portion 25 of the first contact 20 in the height direction. In another word, the contacting portions 25 of the grounding contact 21, signal contacts 23, and power contact 22 in the first contacts 20 are aligned with the contacting portions 35 of the power contact 32, signal contacts 33, and grounding contact 31 in the second contacts 30 in sequence.

The inner circuit board 40 is disposed between the contacting portions 25 of the first contacts 20 and the contacting portions 35 of the second contacts 30. The contacting portions 25 of the first contacts 20 are attached to an upper surface of the inner circuit board 40, the suspending portions 26 extending backwardly beyond the inner circuit board 40. The contacting portions 35 of the second contacts 30 are attached to a lower surface of the inner circuit board 40. The first contacts 20 electrically connect to the respective second contacts 30 via the inner circuit board 40. To be specific, the grounding contacts 21, 31, the signal contacts 23, 33, and the power contacts 22, 33 of the first and second contacts 20, 30 are electrically connected to each other via the inner circuit board 40, therefore, the second contacts 30 could electrically connects to the printed circuit board or wires via the respective first contacts 20, and the second contacts 30 do not need any other portions like tail portions, connecting portions, etc. The second contacts 30 are made from metal sheet for wear resistance. In alternative embodiments, the second contacts 30 could be gold fingers formed by the inner circuit board 40 directly, or the second contacts 30 could contact with the respective first contacts 20 directly or integrally formed with the respective first contacts 20 so as to omit the inner circuit board 40.

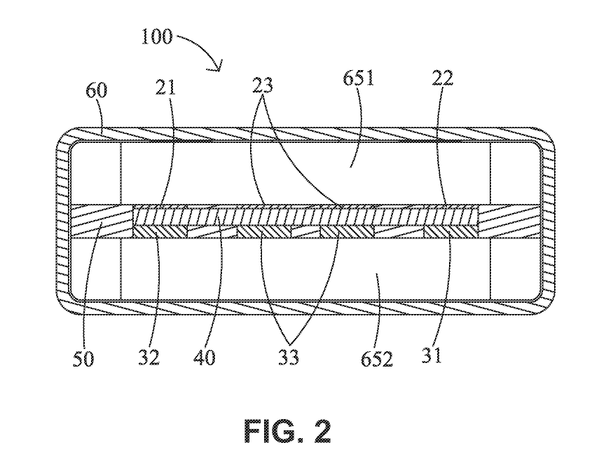

Referring to FIGS. 2-6, the insulator 50 is molded over the contacting portions 25, 35 of the first and second contacts 20, 30, and inner circuit board 40 simultaneously, the contact portions 25, 35 are exposed onto upper and lower surfaces of the insulator 50 for contacting with terminals of a complementary receptacle connector (not shown) which is used for mating with the electrical connector 100. In an alternative embodiment, the insulator 50 is assembled onto the inner circuit board 40.

Referring to FIGS. 1-3, The metal shell 60 includes a top wall 61, a bottom wall 62 opposite to the top wall 61, and a pair of side walls 63 connecting with the top and bottom walls 61, 62. A chamber 65 is formed among the top wall 61, the bottom wall 62 and the side walls 63 for insertion of a tongue of the receptacle connector. The insulator 50 is disposed in middle portion of the chamber 65 to divide the chamber 65 into upper and lower chambers 651, 652. The insulator 50 also severs as a tongue plate for mating with the tongue of the receptacle connector. The upper and lower chambers 651, 652 are symmetric in both height and width directions of the metal shell 60. To be specific, the upper and lower chambers 651, 652 have the same widths and heights, and are aligned with each other in both height direction and width direction. The top and bottom walls 61, 62 locate at upper and lower sides of the insulator 50 respectively. A clearance is formed between each side of the insulator 50 and the respective side wall 63, so as to make sure the insulator 50 could be suspended in the chamber 65 and move upwardly and downwardly without interference with the side walls 63. The contacting portions 25 of the first contacts 20 are exposed into the upper chamber 651, the suspending portions 26 are suspended in the upper chamber 651. The contacting portions 35 of the second contacts 30 are exposed into the lower chamber 652.

The electrical connector 100 of the present invention is reversible for mating with the receptacle connector. When the electrical connector 100 mates with the receptacle connector in a normal orientation, the tongue of the receptacle connector enters into the upper chamber 651 to make sure the terminals contacting with the contacting portions 25 of the first contacts 20. When the electrical connector 100 mates with the receptacle connector in a reverse orientation, the tongue of the receptacle connector enters into the lower chamber 652 to make sure said terminals contacting with the contacting portions 35 of the second contacts 30. Therefore, the electrical connector 100 of the present invention can prevent users or consumers from mis-mating and make it very convenient for users to mate with the receptacle connector. Furthermore, the suspending portion 26 could resiliently swing in a height direction around the connecting portion 27 so as to make sure the insulator 50 accompanying with the contacting portions 25, 35 and the inner circuit board 40 can move upwardly and downwardly in the chamber 65, therefore, dimensions of the upper and lower chambers 651, 652 could be enlarged or scaled respectively, insertion and extraction force of the tongue of the receptacle connector for mating with the electrical connector will be reduced for a better and smooth match.

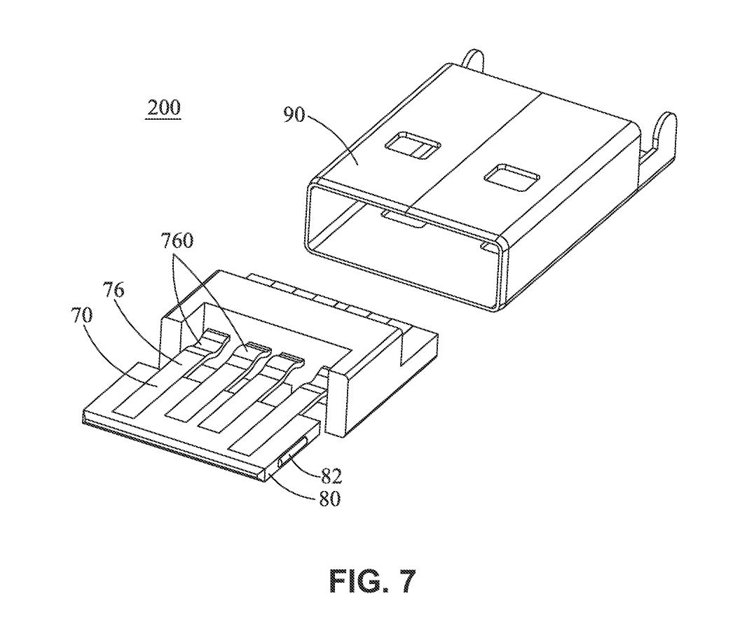

Referring to FIG. 7, according to an electrical connector 200 of another embodiment of the present invention. The suspending portions 76 of the first contacts 70 have curved portions 760 formed at rear ends thereof Curved portions 760 of the two outer first contacts 70 bend downwardly, and curved portions 760 of the two inner first contacts 7 bend upwardly, therefore, the suspending portions 76 have better resilience and balance performance.

The insulator 80 has a pair of protrusions 82 formed at two lateral sides thereof, therefore, frictions between the insulator 80 and the metal shell 90 will be decreased more effectively.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector, comprising:
an insulative housing;
a chamber having upper and lower chambers;
a plurality of first contacts, each having a contacting portion exposed into one of the upper or lower chambers, a connecting portion retained in the insulative housing, and a resilient suspending portion connecting with the contacting portion and the connecting portion; and
a plurality of second contacts, each electrically connecting to respective first contact and having a contacting portion exposed into the other one chamber and aligned to the respective contacting portion of the first contacts;
wherein the suspending portions could resiliently swing in a height direction, and the contacting portions of the first and second contacts can be displaced in the height direction.

2. The electrical connector as claimed in claim 1, wherein the electrical connector further comprises an inner circuit board having opposing surfaces and each of the contacting portions of the first and second contacts is attached to one surface of the inner circuit board, and electrically connected to one contacting portion on the other surface of the inner circuit board.

3. The electrical connector as claimed in claim 2, wherein the inner circuit board is spaced from the insulative housing from a distance and could be displaced in said height direction accompanying with displacement of the contacting portions.

4. The electrical connector as claimed in claim 2, wherein the electrical connector further comprises an insulator molded over the inner circuit board;
and a metal shell defining opposing top and bottom walls, and two opposing side walls connecting the top and bottom walls; the chamber is defined by the walls, the insulator is disposed in the chamber to define the chamber into said upper and lower chambers, the insulator is spaced from the insulative housing for a distance.

5. The electrical connector as claimed in claim 4, wherein each of the suspending portions is suspended in the upper chamber and located at the same height as the contacting portion in said chamber.

6. The electrical connector as claimed in claim 2, wherein the second contacts are gold fingers formed on the inner circuit board directly.

7. The electrical connector as claimed in claim 1, wherein the insulative housing includes a main body and a pair of extending portions extending forwardly from two lateral sides of the main body; the extending portions defining a receiving space formed therebetween; the suspending portions are arranged in the receiving space.

8. The electrical connector as claimed in claim 1, wherein both the first contacts and the second contacts are compatible to the universal serial bus (USB) 2.0 standard, include a grounding contact, a power contact, and a pair of signal contacts locating between the corresponding grounding contact and power contact under condition that the second contacts are arranged in a reverse order compared with the first contacts.

9. The electrical connector as claimed in claim 1, wherein the second contacts are spaced from the insulative housing for a distance, the suspending portions have curved portions formed at rear ends thereof, some of the curved portions bent downwardly, and the other curved portions bent upwardly.

10. An electrical connector for reversibly mating with a complementary connector, comprising:
a metal shell defining a chamber;
a tongue plate disposed in the chamber and dividing the chamber into two symmetrical half chambers;
a plurality of first contacts defining contacting portions located at a surface of the tongue plate and exposed into one of the half chambers for contacting with a group of terminals of the complementary connector when the electrical connector mating with the complementary connector in a normal orientation; and
a plurality of second contacts, each electrically connecting to one respective first contact, the second contacts defining contacting portions arranged at an opposing surface of the tongue plate and being exposed into the other one of said half chambers for contacting with said group of terminals of the complementary connector when the electrical connector mating with the complementary connector in a reverse orientation;
wherein each of said first contacts has resilient suspending portion extending from the respective contacting portion for resiliently bending in a height direction, and the tongue plate pivoted with the contacting portions to adjust dimensions of the half chambers for the complementary connector.

11. The electrical connector as claimed in claim 10, wherein the electrical connector further comprises an insulative housing spaced from the tongue plate in a mating direction perpendicular to the height direction, each of the first contacts has a connecting portion connecting to the respective suspending portions and being retained in the insulative housing.

12. The electrical connector as claimed in claim 11, wherein the insulative housing has a main body, a supporting portion extending rearwardly from the main body and a pair of extending portions extending forwardly from two sides of the main body, each of the first contacts further has a tail portion retained in the supporting portion and exposed to exterior, the extending portions are disposed at two lateral sides of the first contacts and define a receiving space therebetween, the suspending portions are arranged in the receiving space.

13. The electrical connector as claimed in claim 10, wherein the electrical connector further comprises an inner circuit board retained in the tongue plate and between the contacting portions of the first and second contacts, the contacting portions of the first and second contacts are mounted at two opposition surfaces of the inner circuit board to electrically connect respective one on the other surface of the inner circuit board.

14. The electrical connector as claimed in claim 13, wherein the tongue plate has two clearances between respective two sides and the metal shell to make sure the tongue plate being capable displaced in the chamber in the height direction without interference.

15. The electrical connector as claimed in claim 14, wherein the tongue plate has a pair of protrusions formed at two lateral sides thereof and spaced from the metal shell to reduce frictions between the tongue plate and the metal shell.

16. A reversible electrical connector, comprising:
a metal shell defining a chamber having two symmetrical upper and lower chambers;
an inner circuit board disposed between the upper and lower chambers;
a plurality of first contacts having contacting portions deployed on an upper surface of the inner circuit board and exposed into the upper chamber, and resilient suspending portions extending from the contacting portions away to the inner circuit board; and
a plurality of second contacts electrically connecting to the first contacts, each of the second contacts having a contacting portion mounted onto a lower surface of the inner circuit board and exposed into the lower chamber, each of said the contacting portions of the second contacts being electrically connected to each one contacting portion of the respective first contact;
wherein the suspending portions resiliently bend in a height direction , the inner circuit board pivots with the contacting portions when a matched connector inserted in said chamber.

17. The electrical connector as claimed in claim 16, wherein the electrical connector further comprises an insulative housing being spaced from the inner circuit board and the contacting portions of the second contacts, each of the first contacts has a connecting portion extending from the respective suspending portion and being retained in the insulative housing, the suspending portions swing around the respective connecting portions.

18. The electrical connector as claimed in claim 17, wherein the electrical connector further comprises an insulator molded over the contacting portions of the first and second contacts and the inner circuit board, the contacting portions of the first and second contacts are exposed on said surfaces of the insulator, the insulator is spaced from the insulative housing with a distance and is pivoted upwardly or downwardly with the contacting portions and the inner circuit board.

19. The electrical connector as claimed in claim 18, wherein clearances are formed between each lateral side of the insulator and the metal shell.

20. The electrical connector as claimed in claim 17, wherein the suspending portions have curved portions bent downwardly or upwardly relating to the contacting portions.
